(19) United States
(12) Patent Application Publication
(10) Pub. No.: US 2014/0085924 A1
(43) Pub. Date: Mar. 27, 2014

(54) EDGE-LIT LIGHT PANEL

(71) Applicant: OSRAM SYLVANIA INC., Danvers, MA (US)

(72) Inventors: Ming Li, Acton, MA (US); Qiong Huang, Winchester, MA (US); Yi Yang, Peabody, MA (US); Camil-Daniel Ghiu, Danvers, MA (US)

(73) Assignee: OSRAM SYLVANIA INC., Danvers, MA (US)

(21) Appl. No.: 13/628,770

(22) Filed: Sep. 27, 2012

(51) Int. Cl. F21V 8/00

(52) U.S. Cl. 362/606

(57) ABSTRACT

An edge-lit light panel is disclosed, which includes a generally planar, transparent light guide. Light, such as from one or more solid state light source arrays, is coupled into the light guide through its lateral edge, and propagates generally laterally within the light guide via total internal reflection. A diffuser is attached to the front or rear face of the light guide, such as by lamination. The diffuser may have a refractive index matched to that of the light guide. The light guide may have one or more concave features on its lateral edge to reduce reflection losses at high angles of incidence. The concave features may include a single, one-dimensional groove that includes all the solid state light sources along a particular straight edge of the light panel, or may include a series of concave dimples, with one dimple for each solid state light source.

### TECHNICAL FIELD

The present invention relates to lighting, and more specifically, to an edge-lit light panel.

### BACKGROUND

Edge-lit light panels are particularly handy for the purposes of office lighting, retail lighting, signage lighting, and so forth. In an edge-lit light panel, one or more light sources direct light into a light guide through its lateral edge. The light propagates generally laterally within the light guide, reflecting off its front and back surfaces through total internal reflection. Typically, the light guide includes a diffuser within its volume or on its front or back surfaces, which redirects the internal light out of the light guide into a desired pattern.

### SUMMARY

Conventional edge-lit light panels suffer from a variety of deficiencies. For instance, there may be excessive reflection losses incurred as light is coupled into the light guide at its lateral edge. In addition, because the light guides are typically molded from a non-bendable material, it is difficult to change the geometry of the light guide once a part has been manufactured. Finally, if the properties of a light source are varied, it generally requires a redesign of the light guide, which can be time-consuming and expensive. Accordingly, there exists a need for a light panel that can reduce reflection losses at the lateral edge of the light guide, and that can accommodate different light sources without a redesign of the light guide.

Embodiments disclosed herein provide a light panel including a transparent light guide having a front face, a rear face and a lateral perimeter. The light guide is capable of receiving light through its lateral perimeter and laterally transmitting the light via total internal reflection. The light panel also includes a diffuser attached to the front face or the rear face of the light guide. The diffuser has a non-uniform diffusivity that varies over a lateral extent of the diffuser. The diffuser is capable of coupling light out of the light guide and transmitting said light into a predetermined distribution generally perpendicular to the light panel. In some embodiments, the light panel also includes at least one concave feature disposed on the lateral perimeter. Light produced from a light source disposed proximate a center of the concave feature enters through the concave feature and forms internal light having a range of propagation angles. The range includes central propagation angles and peripheral propagation angles. In some embodiments, the light panel also includes at least one inclined surface disposed on the lateral perimeter. Internal light at the peripheral propagation angles is received by the at least one inclined surface and is totally internally reflected by the at least one inclined surface. Internal light at the central propagation angles misses the at least one inclined surface.

In an embodiment, there is provided a light panel. The light panel includes: a transparent light guide having a front face, a rear face and a lateral perimeter, the transparent light guide being capable of receiving light through its lateral perimeter and laterally transmitting the light via total internal reflection; and a diffuser attached to the front face or the rear face of the transparent light guide, the diffuser having a non-uniform diffusivity that varies over a lateral extent of the diffuser, the diffuser being capable of coupling light out of the transparent light guide and transmitting the light into a predetermined distribution generally perpendicular to the light panel.

In a related embodiment, the diffusivity may increase away from a lateral perimeter of the diffuser. In another related embodiment, the diffuser may have a smooth side adhered to the front face or the rear face of the light guide. In yet another related embodiment, the diffuser may be laminated onto the light guide.

In still another related embodiment, the diffuser may be a volume diffuser. In a further related embodiment, the volume diffuser may include a plurality of particles having a refractive index differing from that of a background material, and the density of the plurality of particles may increase away from the lateral perimeter of the diffuser. In a further related embodiment, the density of the plurality of particles may be a maximum at a central region of the light panel. In another further related embodiment, the light panel, the light guide, and the diffuser may each have a generally rectangular perimeter, the diffuser may have a plurality of concentric bands, the density of particles may be generally uniform within each concentric band in the plurality of concentric bands, and a central band in the plurality of concentric bands may have a peak particle density.

In yet still another related embodiment, the diffuser may be a surface diffuser having one or more diffusing features on at least one of the front and rear surfaces of the diffuser.

In another embodiment, there is provided a light panel. The light panel includes: a transparent light guide having a lateral perimeter, the transparent light guide being capable of receiving light through its lateral perimeter and laterally transmitting the light via total internal reflection; at least one concave feature disposed on the lateral perimeter, wherein light produced from a light source disposed proximate a center of the concave feature enters through the concave feature and forms internal light having a range of propagation angles, the range including central propagation angles and peripheral propagation angles; and at least one inclined surface disposed on the lateral perimeter, wherein internal light at the peripheral propagation angles is received by the at least one inclined surface and is totally internally reflected by the at least one inclined surface, and wherein internal light at the central propagation angles misses the at least one inclined surface.

In a related embodiment, the at least one concave feature may have a circular cross-section. In another related embodiment, the light source may be a plurality of solid state light sources, and the light panel may further include the plurality of solid state light sources.

In a further related embodiment, each solid state light source in the plurality of solid state light sources may have a corresponding concave feature and may be disposed proximate the center of the corresponding concave feature. In a further related embodiment, each solid state light source in the plurality of solid state light sources may have a corresponding dome disposed between the solids state light source and the corresponding concave feature.

In another further related embodiment, at each point of the inclined surface, a light ray originating at a solid state light source, passing through the concave feature and striking the inclined surface may strike the inclined surface at an incident angle greater than the critical angle, thereby leading to total internal reflection of the light ray.

In still another related embodiment, each inclined surface may be a flat bevel extending along an edge of the light panel. In yet another related embodiment, each inclined surface may be a rounded, convex bevel extending inward from a front or back surface of the light guide to a lateral edge of the light guide. In still yet another related embodiment, the at least one concave feature and the inclined surface may be integral with the light guide. In yet still another related embodiment, the at least one concave feature and the inclined surface may be included on a lateral feature element, the lateral feature element being separate from and attached to the light guide. In still another related embodiment, at least one side of the lateral perimeter may include: a lateral edge being generally flat and perpendicular to front and rear faces of the light guide; a plurality of concave features disposed in a line along the lateral edge, each concave feature being generally spherical and extending into the light panel from the lateral edge; a pair of inclined surfaces extending from the front and rear faces of the light guide to the lateral edge, respectively, the pair of inclined surfaces being symmetrical from the front to the rear and from the rear to the front, respectively; wherein for light entering the light panel through a concave feature and striking one of the inclined surfaces, the light may be totally internally reflected.

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a front-view drawing of an edge-lit light panel according to embodiments disclosed herein.

FIG. 2 is a side-view cross-section drawing of the edge-lit light panel of FIG. 1 according to embodiments disclosed herein, where the diffuser is a volume diffuser.

FIG. 3 is a side-view cross-section drawing of the edge-lit light panel of FIG. 1 according to embodiments disclosed herein, where the diffuser is a surface diffuser.

FIG. 4 is a front-to-back cross-section drawing of the edge-lit light panel of FIG. 1 according to embodiments disclosed herein, where the lateral edge of the light guide includes a concave groove.

FIG. 5 is a front-to-back cross-section drawing of the edge-lit light panel of FIG. 1 according to embodiments disclosed herein, where the lateral edge of the light guide includes multiple concave features.

FIG. 6 is a side-view cross-section drawing of an edge-lit light panel according to embodiments disclosed herein, in which the inclined portion is a single, flat surface.

FIG. 7 is a side-view cross-section drawing of an edge-lit light panel according to embodiments disclosed herein, in which the inclined portion is a single, curved surface.

FIG. 8 is a side-view cross-section drawing of an edge-lit light panel according to embodiments disclosed herein, in which the lateral features are included on an attached element.

FIG. 9 is a side-view cross-section drawing of an edge-lit light panel according to embodiments disclosed herein, in which the lateral features are included on an attached element, and the attached element has an attachment feature

FIG. 10 is a side-view cross-section drawing of an edge-lit light panel according to embodiments disclosed herein, in which the LED includes a dome, and the dome is separated by an air gap from the concave structure.

FIG. 11 is a side-view cross-section drawing of an edge-lit light panel according to embodiments disclosed herein, in which the LED includes a dome, and the dome contacts the concave structure.

### DETAILED DESCRIPTION

Throughout, the directional terms “up”, “down”, “top”, “bottom”, “side”, “lateral”, “longitudinal” and the like are used to describe the absolute and relative orientations of particular elements. For these descriptions, it is assumed that light exits through a “front” of the light panel, with a spatial distribution centered around a longitudinal axis that is generally perpendicular to the front of the light panel. It will be understood that while such descriptions provide orientations that occur in typical use, other orientations are certainly possible. The noted descriptive terms, as used herein, still apply if the light panel is pointed upward, downward, horizontally, or in any other suitable orientation.

An edge-lit light panel is disclosed, which includes a transparent light guide. Light, such as from one or more LED arrays, is coupled into the light guide through its lateral edge, and propagates generally laterally within the light guide via total internal reflection. A diffuser is attached to the front or rear face of the light guide, such as by lamination. The diffuser may have a refractive index matched to that of the light guide. The light guide may have one or more concave features on its lateral edge to reduce reflection losses at high angles of incidence. The concave features may include a single, one-dimensional groove that includes all the LEDs along a particular straight edge of the light panel, or may include a series of concave dimples, with one dimple for each LED.

The above paragraph is merely a generalization of several of the elements and features described in detail below, and should not be construed as limiting in any way.

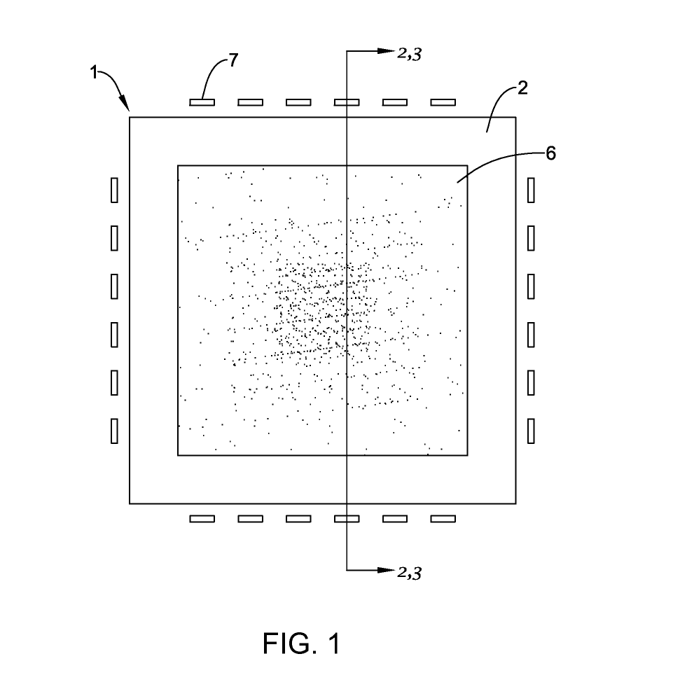

FIG. 1 is a front-view drawing of a light panel 1. The light panel 1 includes a generally planar, transparent light guide 2. Here, the term “generally planar” is intended to include slight deviations from true planar. For instance, if a truly planar light guide 2 were to have a constant thickness at all points along its lateral surface, then a “generally planar” light guide 2 might have a slight wedge between the front and back sides, a slight curvature to its front and/or rear surfaces, a local minimum or maximum in thickness at the center or at another location on the light guide 2, or other slight deviation from true planarity. In general, a “generally planar” light guide 2 will still satisfy the condition of total internal reflection, where light coupled into the light guide along its lateral edge will undergo a series of bounces off the front and rear surfaces of the light guide 2 due to total internal reflection. Light coupled in from the lateral edge will propagate generally laterally within the light guide 2, as it bounces between the front and rear surfaces of the light guide 2. The thickness of the light guide 2 is generally much less than the lateral dimensions of the light guide 2, so that the light guide may resemble a sheet.

In general, the shape of a footprint of the light panel 1 is largely aesthetic, and depends on the particular design requirements for the light panel 1. For instance, if the light panel 1 is to be used in office overhead lighting, it may be desirable to have the light panel 1 be square to fit into a two foot by two foot ceiling grid panel, or be rectangular to fit into two adjacent two foot by two foot ceiling grid panels. The footprint of the light guide 2 may be generally rectangular, as shown in FIG. 1, but may also be any other suitable shape, such as but not limited to a round, elliptical, elongated, polygonal, triangular, square, and/or hexagonal shape, and the like. In some embodiments, the lateral perimeter of the light guide includes various straight segments, as shown in FIG. 1, while in some embodiments, it also includes one or more curved segments, and in some embodiments, it include only one or more curved segments without any straight segments.

The light panel 1, as drawn in FIG. 1, is intended to include the light guide 2 and the diffuser 6. In practice, a light-producing device, such as a ceiling-mounted light fixture, typically also includes light sources that direct light into the lateral perimeter of the light guide 2. Such light sources 7 are shown in FIG. 1, even though they may not be strictly considered part of the light panel 1. Typical light sources 7 may be one or more arrays of solid state light sources, such as but not limited to light emitting diodes (LEDs) and their various related cousins, mounted around the lateral perimeter of the light guide 2, directing their respective outputs into the light guide through the lateral edge or edges of the light guide 2. It is assumed that the solid state light source arrays also include a structure to support the solid state light source chips or facets, circuitry to power the solid state light source chips or facets, and suitable thermal management (e.g., heat sinking) for the solid state light source chips or facets. These additional features are generally well-known, and none are shown in FIG. 1. Typically, the solid state light source arrays 7 may be made in strips, with a strip covering a respective straight edge along the lateral perimeter of the light guide 2. These strips may be made flexible, so that a strip may curve around a rounded edge of the light guide 2, if needed.

The above description includes light propagating within the light guide 2, which is from total internal reflection from the front and back sides of the light guide 2. Below is described a mechanism for coupling light out of the light guide, which involves a diffuser attached to the front or back surfaces of the light guide 2, and a mechanism for coupling light into the light guide 2, which can reduce reflection losses at the lateral perimeter of the light guide 2.

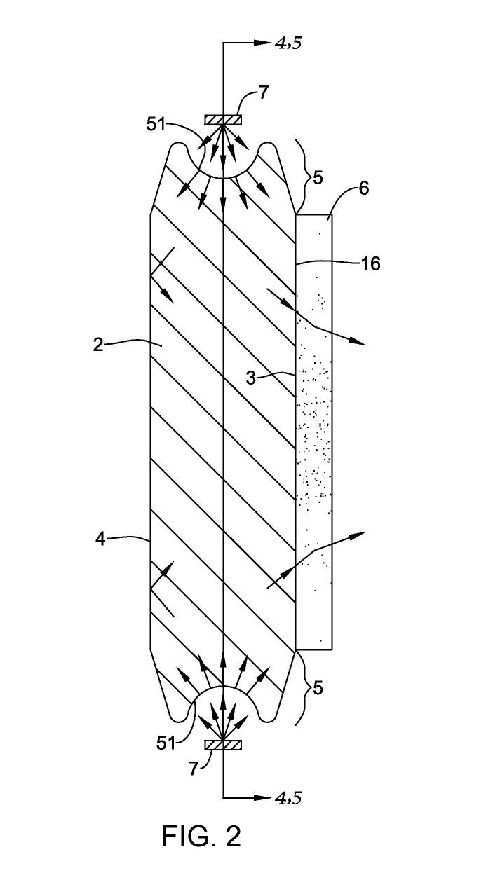

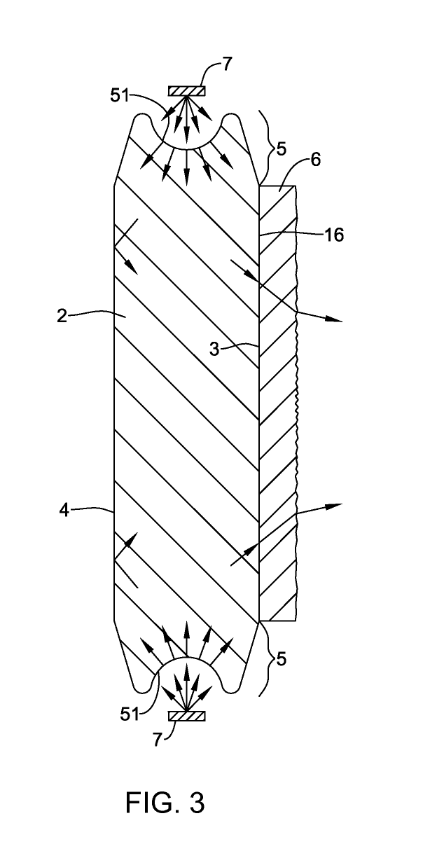

FIGS. 2 and 3 are side-view cross-sections of the light panel 1 from FIG. 1. In both figures, the light panel 1 includes a diffuser 6 having a smooth surface 16 attached to the front surface 3 of the light guide 2. Note that in some embodiments, the diffuser 6 may be attached to the rear surface 4 of the light guide 2, instead of or in addition to the front surface 3. In some cases, there may be more than one diffuser 6. In FIG. 2, the diffuser 6 is a volume diffuser. In FIG. 3, the diffuser 6 is a surface diffuser. The mechanisms of operation are similar, and are explained below.

If there were no diffusing element on, in or attached to the light guide 2, then light entering from a lateral edge would propagate along the full lateral extent of the light guide 2 via multiple total internal reflections from its front 3 and back 4 surfaces, and would fail to exit the light guide in a desired manner. In other words, the light panel 1 would not be emitting light across its lateral surface with the desired angular profile. In order to couple light out of the light panel 1, an element in, on, or attached to the light guide 2 has to disrupt the conditions that lead to total internal reflection. Such an element is a diffuser 6, and in FIGS. 2 and 3, the diffuser 6 has a smooth side 16 attached to the front face 3 of the light guide 2. Alternatively, in some embodiments, the diffuser 6 is attached to the rear face of the light guide 2. As a further alternative, in some embodiments, the light panel 1 includes two diffusers, attached to the front 3 and rear 4 faces of the light guide 2. As a still further alternative, in some embodiments, the diffuser 6 is grown or deposited on one or more faces of the light guide 2, rather than being fabricated beforehand and then attached afterwards. In all of these embodiments, light exits the light panel 1 through the front face 3, toward a viewer.

FIG. 2 shows a side-view cross-section of the light guide 2, along with solid state light source arrays 7 and a volume diffuser 6. The volume diffuser 6 includes a base material, or substrate, which can be matched in refractive index to the light guide 2. The volume diffuser 6 also includes many small particles in suspension, where the particles have a refractive index slightly different from that of the base material. The light guide 2 and the base material of the diffuser 6 may be matched in refractive index, so that when light exits the light guide 2 and enters the diffuser 6 through the smooth side 16, there is no significant reflection at the interface between them. A light ray cross that interface continues in the same direction, since there is no significant different in refractive index across the interface. When a light ray hits one of the particles in suspension, it bends slightly due to Snell's Law, and changes direction slightly upon exiting the particle. Such a change in direction, averaged statistically over many, many particles and many light rays, may disrupt the condition of total internal reflection sufficiently to produce a useful output through the front face 3 of the light guide 2. The output properties are dependent on the size, shape, refractive index and distribution of the particles within the base material. The calculation of light output as a function of these particle properties may be done at the design/simulation stage, and may be handled by known, specialized software that can perform these calculations statistically.

Note that if the particles, all of a known size distribution, were uniformly distributed throughout the diffuser 6, then the output from the diffuser would be brightest near its lateral edges, and would decrease toward the center of the diffuser 6. In other words, if the diffuser were uniform, the diffuser would pick off a fraction of the available light for each unit of area; such a “picking off” would lead to dimmed light at the center because less light is available to “pick off”. As a result, the diffuser 6 should be non-uniform, with more diffusivity at its center than at its edges. The non-uniformity may be achieved by changing the size distribution of particles, the refractive index of particles, or the particle density within the diffuser 6. It is assumed that the design/simulation phase of the light panel 1 may produce sufficient specifications for the diffuser 6, so that output of the light panel 1, through the diffuser 6, may achieve the desired specifications. For instance, if the light panel 1 is used for lighting, the panel 1 may have a specification for brightness of a maximum deviation from uniformity, as a function of area and/or angle. Other suitable specifications may be used as well.

FIG. 2 shows a volume diffuser, where the conditions for total internal reflection are disrupted throughout the thickness of the diffuser 6. As an alternative, FIG. 3 shows a surface diffuser, where the side opposite the smooth side 16 includes surface features that may also disrupt the conditions for total internal reflection. For instance, a typical surface diffuser may use printed dots, one-dimensional and two-dimensional groove, and/or three-dimensional micro-structures that are produced by injection molding, extrusion and/or laser drilling. Optionally, some or all of the surface features may be direction-dependent, and may have very different effects for light traveling “top to bottom” and traveling “left to right” in the light guide 2. For instance, a direction-dependent feature may include small mirrors, prisms or reflectors disposed at the diffusing surface.

In general, the diffuser 6, whether a surface diffuser and/or a volume diffuser, is manufactured separately from the light guide 2, and is then attached to the light guide 2. The attachment may be via lamination, adhesive, welding, optical contacting or any suitable method. Note that in some embodiments, the light extraction properties of the diffuser 6 are used to produce different lit appearances for the light panel 1, depending on viewing angle or viewing location. Note that in some embodiments, the light extraction properties of the diffuser 6 are used to control the beam angle of light exiting the light panel 1. Note that in some embodiments, the light extraction properties of the diffuser 6 are used to account for light guides 2 having various footprints, such as rectangular, non-rectangular, round, curved, out-of-plane, and so forth. Note that in some embodiments, the light extraction properties of the diffuser 6 are used to control the color of the light panel output (assuming that some of the solid state light sources in the arrays 7 have differing colors). Thus, in some embodiments, at least two of the solid state light sources in the arrays 7 emit light having different colors. In some embodiments, the relative amounts of differently colored light are controlled by a closed-loop color mixing feedback system. In some embodiments, the color mixing feedback system includes a thermal sensor. In some embodiments, the color mixing feedback system includes an optical sensor. Any and/or all of these sensors may be mounted proximate the light panel 1, such as but not limited to adjacent to any of the lateral edges, adjacent to the back face, and/or adjacent to the front face of the panel.

A mechanism for coupling light into the light guide 2 is now described. Light is produced by one or more arrays of solid state light sources 7. In FIG. 1, four solid state light source arrays 7 are used, with one being located along each lateral edge of the light guide 2, and all being directed generally “inward” through the respective lateral edge. In general, light emitted from a solid state light source element has an angular distribution that is centered around a local surface normal to the solid state light source element. A typical radiation pattern (in intensity, or radiated power per solid angle as a function of direction) from a solid state light source element surface is Lambertian, which has a maximum value at the surface normal and falls to zero at angles parallel to the surface. In several of the figures, the radiation pattern is shown schematically as a group of arrows, with the longest arrow being perpendicular to the surface, and progressively shorter arrows at angles that approach tangential to the solid state light source emission surface. In some known systems, in which the lateral edge of the light guide 2 is flat and parallel to the plane of the solid state light source element, there may be excessive losses due to reflection for high angles of incidence at the flat lateral surface of the light guide 2. For some typical refractive index values for an uncoated light guide 2, the losses due to reflection at normal incidence are around 4% to 5%. For one polarization, these losses rise monotonically to essentially 100% at grazing incidence; for the other polarization, the losses drop to zero (at the condition of Brewster's angle), then rise to essentially 100% at grazing incidence. For flat lateral edges, these losses are essentially independent of the distance between the solid state light source and the lateral edge of the light guide 2; the losses do not disappear even if the solid state light source is brought very close to the lateral edge.

For the light guide 2 of FIG. 1, these losses are reduced by forming one or more concave structures 51 in the lateral edge of the light guide 2 at or near the solid state light sources. Such a concave structure 51 can reduce the angle of incidence at the interface between air and the light guide, for light that exits the solid state light source at large angles (i.e., at angles far from the surface normal). If the angle of incidence is reduced when the light enters the light guide 2, the effects of the reflection losses can be reduced. For example, if the lateral edge includes a hollowed-out portion of a sphere, with the solid state light source surface at or near the center of the sphere, much of the light that strikes the concave spherical portion will do so at or near normal incidence, and will see reflection losses much closer to 4% or 5% for most or all of the propagation angles. Compared with the near-100% reflection loss for the high angles of incidence, for the case of a planar lateral edge, this concave structure 51 may be a substantial improvement in reducing the reflection loss.

The concave structure 51 is shown in cross-section in FIGS. 2 and 3. Note that if the concave structure 51 is spherical in cross-section, with the solid state light source 7 at its center, then the actual radius of the concave structure 51 may be varied over a relatively large range without significantly altering its performance. As a secondary effect, if the concave structure 51 is made relatively large compared to the size (extent) of the solid state light source 7, then the performance as a function of angle may be made more uniform, because the solid state light source 7 appears to more closely resemble a point source. Note that adjacent to the concave structure 51, the light guide 2 may taper outward until it reaches its full depth. Such a tapering may help keep light within the light guide 2 due to total internal reflection. The beginning and ending points of the taper may optionally be rounded, which may also assist in keeping light within the light guide 2.

As noted above, the concave structure 51 may be a partial sphere, or other two-dimensional concave structure, where the lateral edge of the light guide 2 has one concave structure for each solid state light source. As an alternative, the lateral edge may have a concave structure 51 that includes more than one solid state light source. For instance, the lateral edge may include a groove that subtends all the solid state light sources along the edge, or a subset of all the solid state light sources. Similarly, there may be multiple concave features along the lateral edge, each of which subtends one or more solid state light sources.

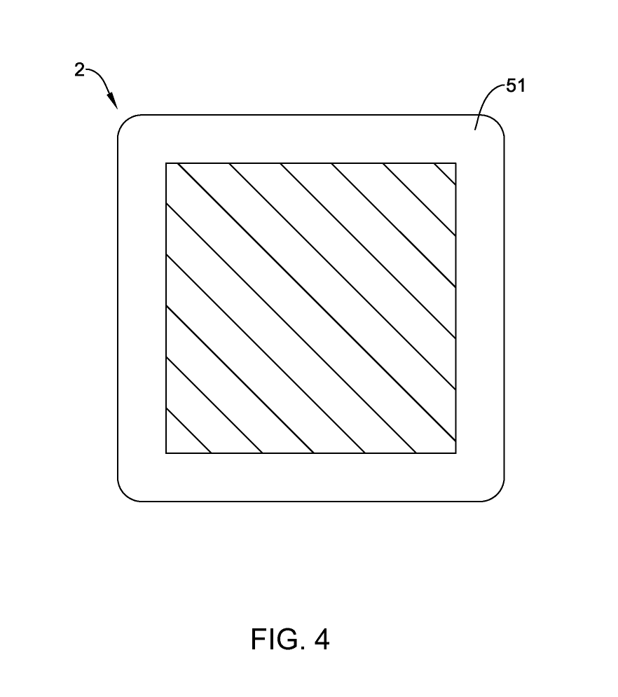

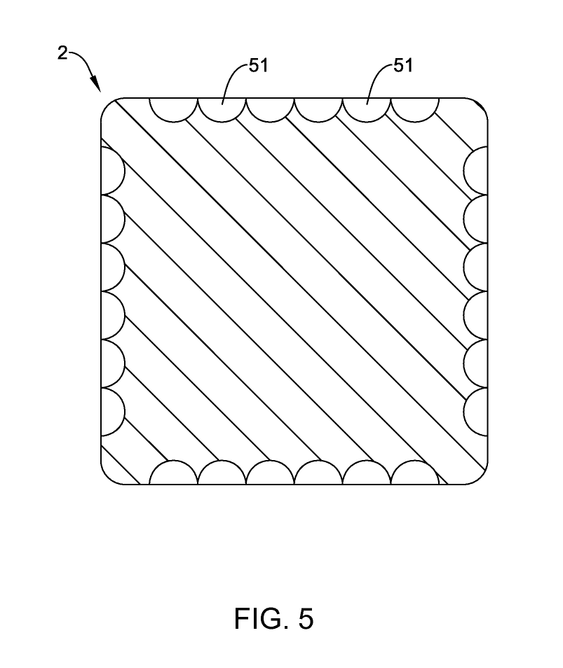

Since the side-view cross-sections in FIGS. 2 and 3 of the concave structure 51 would look the same for many of these cases, FIGS. 4 and 5 show front-to-back cross-sections of the same structures. In FIGS. 4 and 5, a cross-section light guide 2 is taken in a vertical slice, with the slice being parallel to the front of the light guide 2 and bisecting the solid state light sources 7.

In FIG. 4, the concave structure 51 is a groove that extends fully along each lateral edge of the light guide 2, and also extends around the corners of the light guide 2. The rectangular area at the center of FIG. 4 is the light guide material, extending from the “bottom” of the groove on one lateral edge to the “bottom” of the groove on the opposing edge, for both vertical and horizontal directions. The border of the rectangular area, denoted in FIG. 4 with element numeral 51, is the inside of the “back” half of the groove, viewed from the “front”. Similarly, in FIG. 5, the light guide 2 includes a single concave structure 51 for each solid state light source along the lateral perimeter 5 of the light guide 2. Here, the structures 51 are all hollow half-spheres or portions of a sphere. Alternatively, other suitable shapes may be used, including polygonal shapes, irregular curved shapes or shapes having facets or line segments in cross-section. Although all the structures 51 in FIG. 5 are drawn as being the same shape, one or more may be a different shape. In practice, the shapes of both the concave structure(s) 51 and the taper in the light guide thickness at its lateral perimeter 5 may be adjusted in the design/simulation phase, prior to building any actual parts.

It is instructive to examine in more detail the lateral perimeter 5 of the light guide 2. The lateral perimeter 5 may, and in some embodiments does, include two specific features that help reduce losses due to surface reflections incurred when light enters the light guide 2. First, the lateral perimeter 5 may, and in some embodiments does, include a concave structure 51 adjacent to one or more solid state light sources 7, which may reduce the angle of incidence at which the incident rays strike the light guide 2, and may thereby reduce or eliminate the instances of high angles of incidence that may have high power reflectivities. As noted above, the concave structure 51 may be spherical or cylindrical in shape, which may subtend a single solid state light source or several solid state light sources. In general, the cross-sectional shape of the concave structure 51 need not be truly circular to realize the benefits of reducing the angle of incidence, which in turn can reduce the amount of power lost in reflection. For instance, the concave structure 51 may include an elongated dimple, an irregularly shaped dimple, a concave dimple having corners, a concave dimple lacking corners, or any other suitable shape. As a generality, any shape that reduces the angle of incidence entering the light guide 2, for high angles of incidence, may help reduce the amount of light reflected at those high angles of incidence, and may therefore increase the fractional amount of light that enters the light guide 2.

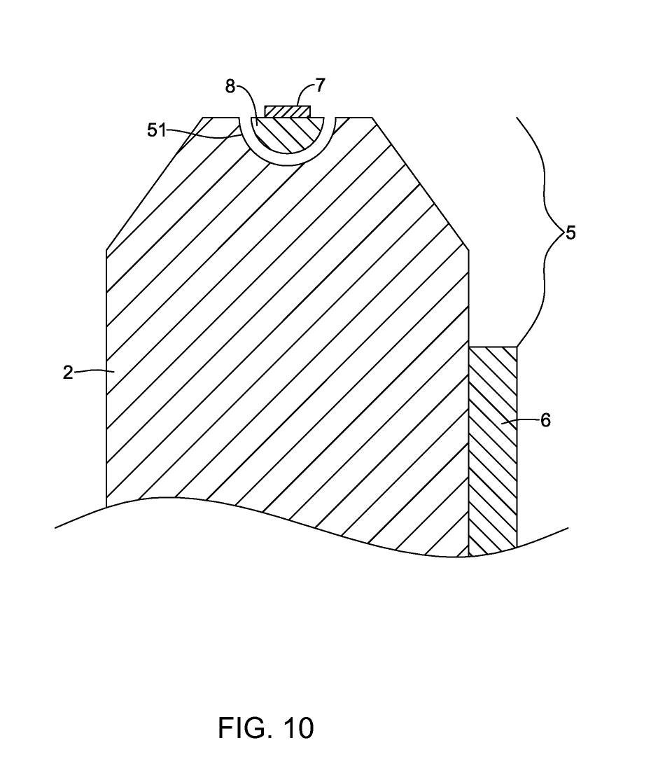

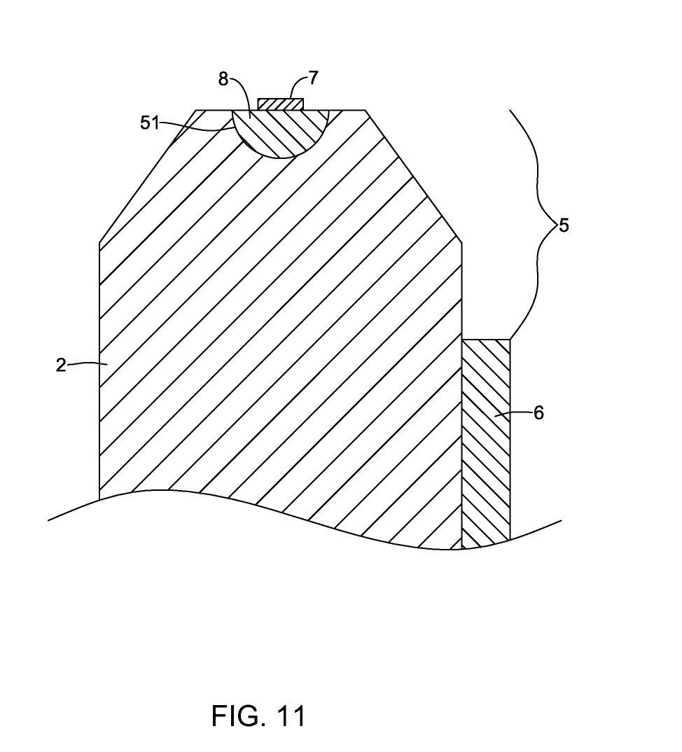

Note that in addition to being beneficial for use with a bare solid state light source emission surface, as is shown in FIGS. 2 and 3, the concave structure 51 may also be beneficial for designs in which the solid state light source emission surface is encapsulated within a dome. For example, FIGS. 10 and 11 show a hemispherical dome 8 mounted on the solid state light source 7. In FIG. 10, there is an air gap between the dome 8 and the concave structure 51, where light emitted by the solid state light source leaving the dome passes through the air gap before striking the concave structure 51. In FIG. 11, the shape of the concave structure 51 is matched to that of the dome 8, so that they may be in contact or may include a thin volume of refractive index-matching fluid between them. For both of these cases, as with those of FIGS. 2 and 3, using the concave structure 51 reduces the angle of incidence for light entering the light guide 2, for light entering at high angles of incidence, i.e., at large angles with respect to a vertical surface normal.

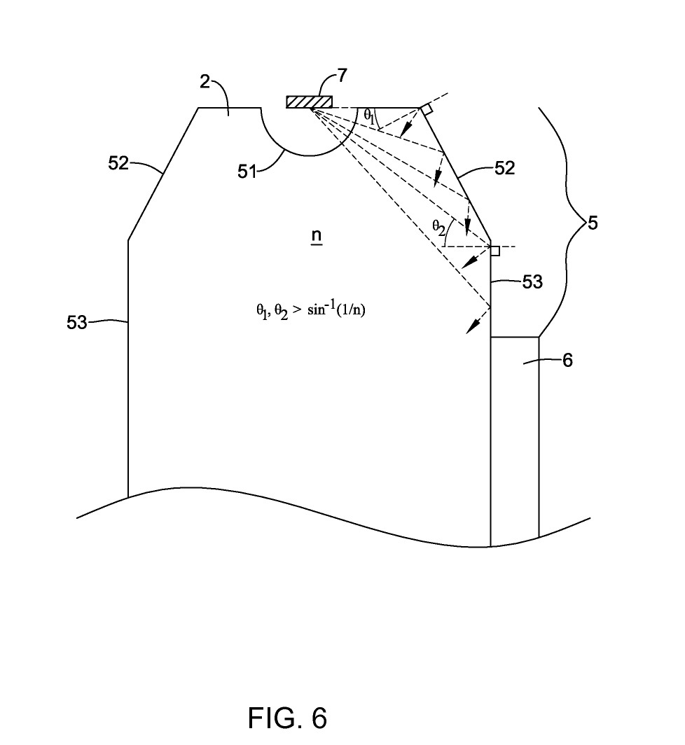

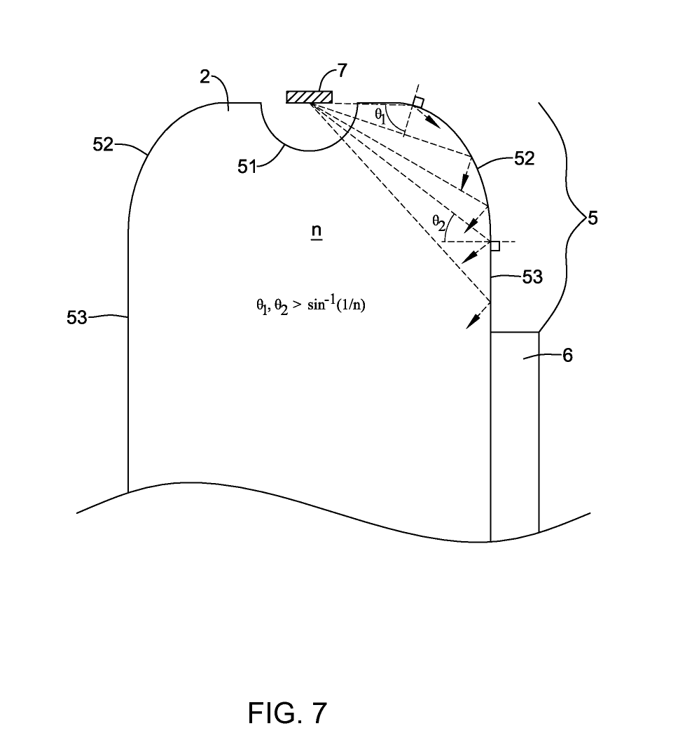

Second, the lateral perimeter 5 may have an inclined portion 52, which can help enforce a condition of total internal reflection inside the light guide 2 for light that has entered through the concave structure 51. Note that if the light guide 2 lacked an inclined portion 52 and were strictly rectangular in all dimensions, then there would be a region near the top of the light guide 2 at which light inside the light guide would fail to satisfy the condition for total internal reflection. In this region, light would undesirably exit the light guide 2. The inclined portion 52 is intended to keep that otherwise-exiting light inside the light guide, by introducing a reflection that directs it downward. Many geometries are possible for the inclined portion 52. Two example geometries are shown in FIGS. 6 and 7, with the understanding that one of ordinary skill in the art may modify these geometries as needed.

FIG. 6 is a side-view cross-section drawing of an example light guide 2, in which the inclined portion 52 is a single, flat surface. The lateral perimeter 5 of the light guide 2 includes a concave feature 51 facing the solid state light source 7, lateral extensions (horizontal in FIG. 6) away from the concave feature 51 toward the front and back of the light guide 2, and flat inclined portions 52 extending between the lateral extensions and the (vertical in FIG. 6) front and back surfaces 53 of the light guide 2. Each inclined portion 52 may be thought of as a flat bevel extending along an edge of the light panel. Some rule-of-thumb conditions are provided with FIG. 6, which may serve as rough guides for the placement and inclination angle of the inclined portion 52. The conditions are derived using several assumptions: (1) the concave structure 51 is circular, with its center being at the center of the emission surface of the solid state light source 7; (2) the rays all appear to emerge from the center of the solid state light source 7 (in practice, the solid state light source 7 has a finite spatial extent, which is easily accounted for during the ray-tracing simulation of the system, but is ignored for this simple set of conditions); and (3) rays strike at the critical angle (of incidence) at the top of the inclined portion 52 and at the top of the front and back surfaces 53 just adjacent to the bottom of the inclined portion 52.

It is assumed that the light guide 2 has a refractive index denoted by n, and that angles of incidence are drawn with respect to the local surface normal. For a ray propagating at almost 90 degrees (horizontally toward the front surface 53 in FIG. 6), angle θ₁ is the critical angle, so that a ray exiting into air would do so at grazing exitance, generally parallel to the surface. The first rule-of-thumb condition is that the inclination angle of the inclined portion 52 is chosen so that θ₁ is greater than sin⁻¹ (1/n). This ensures that any ray that originates from the center of the solid state light source 7 and strikes the inclined surface experiences total internal reflection, and therefore stays inside the light guide 2. This condition puts a general constraint on the inclination angle of the inclined surface.

For a ray propagating toward the bottom of the inclined portion 52, a similar condition holds. We want to ensure that a ray that strikes the front and back surface 53 directly would do so under the condition of total internal reflection, even at the topmost portion of the front and back surface 53. Such a ray forms an angle of incidence (with respect to the local surface normal) of θ₂. The angle θ₂ is the critical angle, so that a ray exiting into air would do so at grazing exitance, generally parallel to the surface and downward in FIG. 6. The second rule-of-thumb condition is that the location of the corner between the inclined portion 52 and the front or back surface 53 is chosen so that θ₂ is greater than sin⁻¹ (1/n). This ensures that any ray that originates from the center of the solid state light source 7 and strikes the front or back surface 53 directly experiences total internal reflection, and therefore stays inside the light guide 2. This condition puts a general constraint on the location of the bottom end of the inclined surface. Given these two rules of thumb, it is possible to use the second rule to define the location of a bottom edge of the inclined portion 52, and to use the first rule to define an inclination angle of the inclined portion 52. It is straightforward to find such a geometry for a given light guide 2.

Note that these rules-of-thumb are simple approximations, and that actual geometry may be specified easily during the simulations performed in the design phase of the device. Such simulations need not strictly adhere to any or all of the three assumptions noted above, since the simulation software is significantly more sophisticated than the simple equations outlined above.

A second example is shown in FIG. 7. Whereas the inclined surface 52 of FIG. 6 was taken to be flat, the inclined surface 52 is curved. Similar rays are shown leaving the solid state light source 7, and similar conditions hold for the top and bottom of the inclined surface 52. The curved portion of the inclined surface 52 is convex in FIG. 7, although the inclined surface 52 may also be concave, or may contain convex and/or concave portions. Similar to FIG. 6, each inclined portion 52 of FIG. 7 may be thought of as a convex, curved bevel extending along an edge of the light panel.

Although the inclined surfaces 52 shown in FIGS. 6 and 7 are single, unbroken surfaces, the inclined surfaces may also include corners, at which the slope of the surfaces experiences a discontinuity. For instance, instead of a single, flat surface, as in FIG. 6, the inclined surface 52 may use two or more smaller flat surfaces with corners between them.

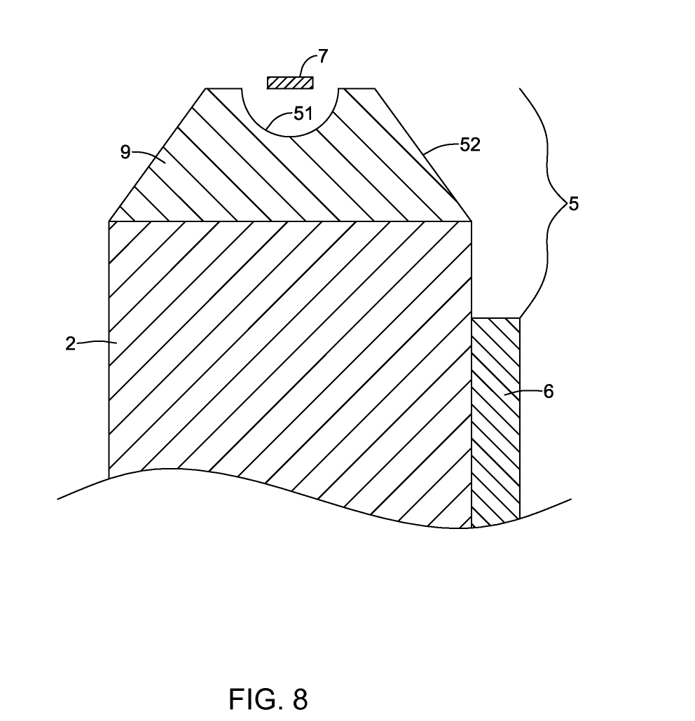

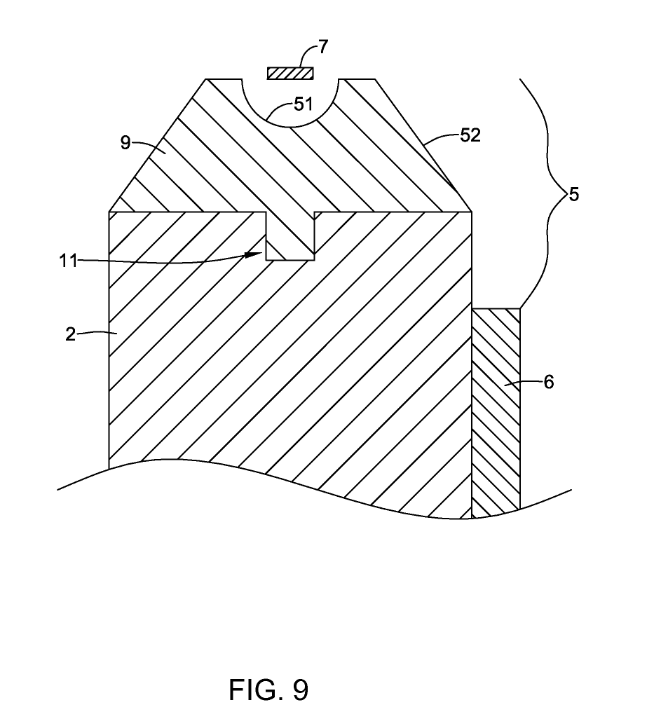

Thus far, it has been assumed that the features on the lateral perimeter 5 of the light guide 2 are made integral with the light guide 2. In some embodiments, it is desirable to form these features on a separate lateral feature element 9, then attach the lateral feature element 9 to the light guide. FIG. 8 shows such an attached lateral feature element 9 attached to the lateral edge of the light guide 2. FIG. 9 shows a similar lateral feature element 9, attached with an attachment feature 11. In the example of FIG. 9, the example attachment features is a groove along the lateral edge of the light guide 2, into which fits a complementary ridge on the lateral feature element 9. Other suitable attachment features may also be used.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

What is claimed is:

1. A light panel, comprising:
a transparent light guide having a front face, a rear face and a lateral perimeter, the transparent light guide being capable of receiving light through its lateral perimeter and laterally transmitting the light via total internal reflection; and
a diffuser attached to the front face or the rear face of the transparent light guide, the diffuser having a non-uniform diffusivity that varies over a lateral extent of the diffuser, the diffuser being capable of coupling light out of the transparent light guide and transmitting the light into a predetermined distribution generally perpendicular to the light panel.

2. The light panel of claim 1, wherein the diffusivity increases away from a lateral perimeter of the diffuser.

3. The light panel of claim 1, wherein the diffuser has a smooth side adhered to the front face or the rear face of the light guide.

4. The light panel of claim 1, wherein the diffuser is laminated onto the light guide.

5. The light panel of claim 1, wherein the diffuser is a volume diffuser.

6. The light panel of claim 5, wherein the volume diffuser comprises a plurality of particles having a refractive index differing from that of a background material, and wherein the density of the plurality of particles increases away from the lateral perimeter of the diffuser.

7. The light panel of claim 6, wherein the density of the plurality of particles is a maximum at a central region of the light panel.

8. The light panel of claim 6, wherein the light panel, the light guide, and the diffuser each have a generally rectangular perimeter, wherein the diffuser has a plurality of concentric bands, wherein the density of particles is generally uniform within each concentric band in the plurality of concentric bands, and wherein a central band in the plurality of concentric bands has a peak particle density.

9. The light panel of claim 1, wherein the diffuser is a surface diffuser having one or more diffusing features on at least one of the front and rear surfaces of the diffuser.

10. A light panel, comprising:
a transparent light guide having a lateral perimeter, the transparent light guide being capable of receiving light through its lateral perimeter and laterally transmitting the light via total internal reflection;
at least one concave feature disposed on the lateral perimeter, wherein light produced from a light source disposed proximate a center of the concave feature enters through the concave feature and forms internal light having a range of propagation angles, the range including central propagation angles and peripheral propagation angles; and
at least one inclined surface disposed on the lateral perimeter, wherein internal light at the peripheral propagation angles is received by the at least one inclined surface and is totally internally reflected by the at least one inclined surface, and wherein internal light at the central propagation angles misses the at least one inclined surface.

11. The light panel of claim 10, wherein the at least one concave feature has a circular cross-section.

12. The light panel of claim 10, wherein the light source is a plurality of solid state light sources, and wherein the light panel further comprises the plurality of solid state light sources.

13. The light panel of claim 12, wherein each solid state light source in the plurality of solid state light sources has a corresponding concave feature and is disposed proximate the center of the corresponding concave feature.

14. The light panel of claim 13, wherein each solid state light source in the plurality of solid state light sources has a corresponding dome disposed between the solids state light source and the corresponding concave feature.

15. The light panel of claim 12, wherein at each point of the inclined surface, a light ray originating at a solid state light source, passing through the concave feature and striking the inclined surface strikes the inclined surface at an incident angle greater than the critical angle, thereby leading to total internal reflection of the light ray.

16. The light panel of claim 10, wherein each inclined surface is a flat bevel extending along an edge of the light panel.

17. The light panel of claim 10, wherein each inclined surface is a rounded, convex bevel extending inward from a front or back surface of the light guide to a lateral edge of the light guide.

18. The light panel of claim 10, wherein the at least one concave feature and the inclined surface are integral with the light guide.

19. The light panel of claim 10, wherein the at least one concave feature and the inclined surface are included on a lateral feature element, the lateral feature element being separate from and attached to the light guide.

20. The light panel of claim 10, wherein at least one side of the lateral perimeter comprises:
a lateral edge being generally flat and perpendicular to front and rear faces of the light guide;
a plurality of concave features disposed in a line along the lateral edge, each concave feature being generally spherical and extending into the light panel from the lateral edge;
a pair of inclined surfaces extending from the front and rear faces of the light guide to the lateral edge, respectively, the pair of inclined surfaces being symmetrical from the front to the rear and from the rear to the front, respectively;
wherein for light entering the light panel through a concave feature and striking one of the inclined surfaces, the light is totally internally reflected.
